(19) United States
(12) Patent Application Publication
(10) Pub. No.: US 2026/0105622 A1
(43) Pub. Date: Apr. 16, 2026

(54) COMPUTATIONALLY EFFICIENT DEPTH MAPPING USING DUAL CAMERAS AND A SPARSE ACTIVE DEPTH SENSOR

(71) Applicant: Meta Platforms Technologies, LLC, Menlo Park, CA (US)

(72) Inventors: Zhongxi Li, Belmont, CA (US); Rakesh Ranjan, Mountain View, CA (US); Wei Ye, Mountain View, CA (US); Jingqing Huang, Mountain View, CA (US)

(21) Appl. No.: 19/356,873

(22) Filed: Oct. 13, 2025

Related U.S. Application Data
(60) Provisional application No. 63/707,634, filed on Oct. 15, 2024.

(51) Int. Cl. G06T 7/593; G06T 9/00

(52) U.S. Cl. CPC G06T 7/593; G06T 9/002; G06T 2207/10028; G06T 2207/20076; G06T 2207/20084

(57) ABSTRACT

An embodiment includes encoding a first 32-bit floating point depth value, in a plurality of 32-bit floating point depth values, into a first signed 8-bit integer and a second signed 8-bit integer. An embodiment includes predicting, using a trained convolutional neural network (CNN), the first signed 8-bit integer, and the second signed 8-bit integer, a plurality of depth layer maps and a probability map. An embodiment includes generating, by selecting pixels from the plurality of depth layer maps according to the probability map, a depth map of a scene.

### CROSS REFERENCE OF RELATED APPLICATION

This application claims the benefit of U.S. Provisional Application No. 63/707634, filed on October 15, 2024, which is incorporated herein in its entirety.

### TECHNICAL FIELD

The present disclosure generally relates to image processing, and more particularly to computationally efficient depth mapping using dual cameras and a sparse active depth sensor.

### BACKGROUND

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user’s visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user’s eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

### SUMMARY

Some embodiments of the present disclosure provide a computer-implemented method for computationally efficient depth mapping using dual cameras and a sparse active depth sensor. The method includes encoding a first 32-bit floating point depth value, in a plurality of 32-bit floating point depth values, into a first signed 8-bit integer and a second signed 8-bit integer; predicting, using a trained convolutional neural network (CNN), the first signed 8-bit integer, and the second signed 8-bit integer, a plurality of depth layer maps and a probability map; and generating, by selecting pixels from the plurality of depth layer maps according to the probability map, a depth map of a scene.

Some embodiments of the present disclosure provide a non-transitory computer-readable medium storing a program for computationally efficient depth mapping using dual cameras and a sparse active depth sensor. The program, when executed by a computer, configures the computer to encode a first 32-bit floating point depth value, in a plurality of 32-bit floating point depth values, into a first signed 8-bit integer and a second signed 8-bit integer; predict, using a trained convolutional neural network (CNN), the first signed 8-bit integer, and the second signed 8-bit integer, a plurality of depth layer maps and a probability map; and generate, by selecting pixels from the plurality of depth layer maps according to the probability map, a depth map of a scene.

Some embodiments of the present disclosure provide a system for computationally efficient depth mapping using dual cameras and a sparse active depth sensor. The system comprises a processor and a non-transitory computer readable medium storing a set of instructions, which when executed by the processor, configure the processor to encode a first 32-bit floating point depth value, in a plurality of 32-bit floating point depth values, into a first signed 8-bit integer and a second signed 8-bit integer; predict, using a trained convolutional neural network (CNN), the first signed 8-bit integer, and the second signed 8-bit integer, a plurality of depth layer maps and a probability map; and generate, by selecting pixels from the plurality of depth layer maps according to the probability map, a depth map of a scene.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement computationally efficient depth mapping using dual cameras and a sparse active depth sensor, according to some embodiments.

FIG. 2 is a block diagram illustrating details of a system for computationally efficient depth mapping using dual cameras and a sparse active depth sensor, according to some embodiments.

FIG. 3 depicts a block diagram of an example configuration for computationally efficient depth mapping using dual cameras and a sparse active depth sensor, in accordance with an illustrative embodiment.

FIG. 4 depicts an example of computationally efficient depth mapping using dual cameras and a sparse active depth sensor, in accordance with an illustrative embodiment.

FIG. 4A depicts more detail of an example of computationally efficient depth mapping using dual cameras and a sparse active depth sensor, in accordance with an illustrative embodiment.

FIG. 4B depicts more detail of another example of computationally efficient depth mapping using dual cameras and a sparse active depth sensor, in accordance with an illustrative embodiment.

FIG. 5 depicts a continued example of computationally efficient depth mapping using dual cameras and a sparse active depth sensor, in accordance with an illustrative embodiment.

FIG. 6 depicts a flowchart of an example process for computationally efficient depth mapping using dual cameras and a sparse active depth sensor, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Real-time depth estimation is an important technology to enable mixed reality. Passive depth estimation uses images from a single or multiple cameras and an algorithm that estimates depth from the images. However, passive depth estimation cannot generate sufficiently accurate depth data at further ranges from the camera due to fundamental physical limitations, is more computationally expensive than desired, and usually fails at textureless areas (e.g., walls, ceilings, and the like). Active depth estimation uses active depth sensors such as sonar or laser to physically measure depth in a space. Active depth estimation is usually sufficiently accurate, but the depth data is less dense than desired for use by downstream mixed reality applications, is more expensive than desired, and has failure cases on certain materials such as glasses, highly reflective surfaces (e.g., mirrors), hair, and the like. Fusion depth estimation typically combines a single camera image with sparse active depth sensor signals and uses the image as guidance to “fill-in” the gaps of the sparse depth sensor signal. Fusion fails on areas of a scene without active sensor data, where the only valid information is the single-camera image and depth estimation from single-camera images is ambiguous and thus insufficiently inaccurate.

Thus, there is a need for an improved fusion method of depth mapping using dual cameras and a sparse active depth sensor, which is computationally efficient enough to execute in real time on existing MR devices such as headsets.

Embodiments of the present disclosure address the above identified problems by implementing computationally efficient depth mapping using dual cameras and a sparse active depth sensor. In particular, an embodiment encodes a first 32-bit floating point depth value, in a plurality of 32-bit floating point depth values, into a first signed 8-bit integer and a second signed 8-bit integer; predicts, using a trained convolutional neural network (CNN), the first signed 8-bit integer, and the second signed 8-bit integer, a plurality of depth layer maps and a probability map; and generates, by selecting pixels from the plurality of depth layer maps according to the probability map, a depth map of a scene.

An embodiment receives depth data of a scene. The depth data is a result of an active depth determination of one or more points in the scene, obtained using an active sensor such as sonar or a laser. Thus, in some embodiments the depth data is a set of points in a three-dimensional coordinate system.

An embodiment uses a presently available technique (e.g., using a transformation based on geometry) to reproject points in the depth data into a camera in a pair of cameras at a target resolution. Some embodiments, used in, e.g., a headset with left and right cameras, compute two reprojected values of a sensor measurement at a target resolution, one each for the left and right cameras, by multiplying a 4x4 left transformation matrix K·[R|t|] by the raw sensor measurements (N points x 4 values for each point) and by multiplying a 4x4 right transformation matrix K·[R|t|] by the same raw sensor measurements. However, the target resolution is usually large enough that reprojecting directly to the target resolution results in sparse two-dimensional maps that are difficult to process in a depth value generation model such as a CNN. Thus, another embodiment, used in, e.g., a headset with left and right cameras, performs two reprojections for the left camera, one at the target resolution (denoted by p1) and one at a lower (e.g., half of the) resolution than the target resolution (denoted by p2), and combines the two reprojections using the expression y = p1 if p1 is empty else p2. The embodiment performs a similar reprojection for the right camera. Although left and right cameras are typical, other camera configurations are also possible and contemplated within the scope of the illustrative embodiments. Combining multiple reprojections in the manner described herein condenses a resulting two-dimensional map for easier processing (as compared to a sparser map) in a depth value generation model such as a CNN. After reprojection, the depth data is in a 32-bit floating point format, and thus there are a plurality of 32-bit floating point depth values.

32-bit floating point depth values are computationally expensive to process in on-device hardware, including through a depth value generation model such as a CNN, potentially causing undesirable latency if the processor(s) implementing the model cannot process 32-bit floating point depth values fast enough to generate a real-time result. Thus, an embodiment encodes a 32-bit floating point depth value into a first signed 8-bit integer and a second signed 8-bit integer. An embodiment computes a first signed 8-bit integer, denoted by y1, using the expression y1 = int8(y*scale1). An embodiment computes a second signed 8-bit integer, denoted by y2, using the expression y2 = int8(sin(y/T)*scale2. Here, scale1, T, and scale2 denote customizable scale factors, int8() denotes a function converting a value into a signed 8-bit integer, and y denotes the projected raw sensor measurement.

Using a trained CNN, a presently available technique, an embodiment uses images from the dual cameras, the first signed 8-bit integer, and the second signed 8-bit integer to predict a plurality of depth layer maps and a probability map. In one embodiment, the trained CNN includes a first encoder portion, a second encoder portion, and a decoder portion. In the embodiment, the first encoder portion uses the signed 8-bit integers to predict one output, the second encoder portion uses the images from the dual cameras to predict another output, and the decoder portion uses the encoder outputs to predict a plurality of depth layer maps and a probability map. The depth layer maps include the CNN’s predicted depth data of a layer of the scene and the probability map includes the CNN’s prediction of the relative weights among the depth layers. For each pixel, the probability value guides the selection among the multiple candidate depth values of the depth layers. The depth layer maps and probability maps are aligned with each other, so that corresponding pixels in each map refer to the same x-y coordinates in the scene. In one embodiment, the plurality of depth layer maps includes a foreground map (comprising depth data of a foreground portion of the scene) and a background map (comprising depth data of a background portion of the scene). In another embodiment, the plurality of depth layer maps includes a foreground map, an intermediate map (comprising depth data of an intermediate-depth portion of the scene), and a background map. In another embodiment, the plurality of depth layer maps includes four or more depth layer maps, each including depth data of a layer of the scene. In some embodiments, the depth layer maps have a lower resolution than the probability map. In one embodiment, the depth layer maps are 320x256 and the probability map is 640x512. In another embodiment, the depth layer maps are 160x128 and the probability map is 640x512. Note that the depth layer maps need not all have the same resolution, and other resolutions for both depth layer and probability maps are also possible and contemplated within the scope of the illustrative embodiments.

An embodiment generates a depth map of a scene by selecting pixels from the plurality of depth layer maps according to the probability map. The depth map of a scene includes predicted depth data for coordinates in the scene that did not have depth data obtained using active sensing. If the depth layer maps are not the same resolution as the probability map, an embodiment converts the depth layer maps to the same resolution as the probability map, for example using bilinear upsampling, a presently available technique. Because the depth layer maps and probability maps are aligned with each other, in an embodiment implementing a foreground and background depth layer maps, the embodiment generates the depth map by selecting a pixel from the foreground depth map if an entry in the probability map corresponding to the pixel is greater than a threshold value (e.g., 0.5), and selecting the corresponding pixel from the background depth map otherwise. In an embodiment implementing foreground, intermediate ground, and background depth layer maps, the embodiment generates the depth map by selecting a pixel from the foreground depth map if an entry in the probability map corresponding to the pixel is greater than a first threshold value (e.g., 0.33), selecting the corresponding pixel from the intermediate ground depth map if the entry in the probability map is between the first threshold value and a second, lower, threshold value (e.g., between 0.33 and 0.66), and selecting the corresponding pixel from the background depth map otherwise. Other embodiments using higher numbers of probability maps select pixels from depth layer maps similarly.

In embodiments, using two signed 8-bit integers as input is faster than using a 32-bit floating point depth value, as the first few layers of an encoder portion of the CNN do not need to perform computations on floating point data. Predicting depth layer maps and combining the results into a final depth map is also faster than using a decoder portion of the CNN to produce a final depth map. As a result, embodiments described herein are computationally efficient enough to execute in real time on existing MR devices such as headsets. In other embodiments, depth values are encoded in a format other than 32-bit floating point and converted to signed 8-bit integer values in a manner described herein. In other embodiments, depth values are encoded in a format other than 32-bit floating point and converted to a format other than signed 8-bit integer (e.g., unsigned 8-bit integer, signed 16-bit integer, and the like) in a manner described herein.

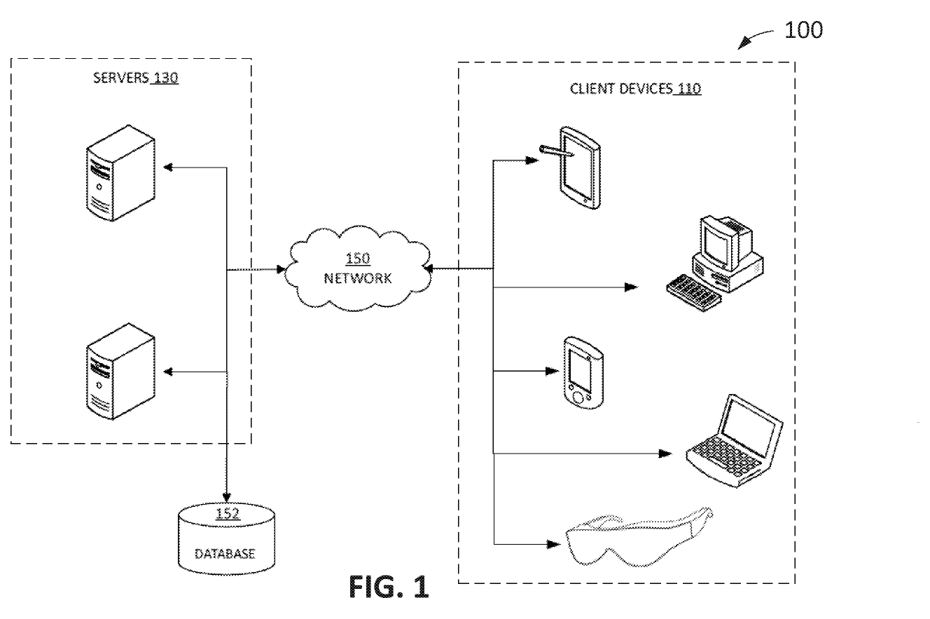

FIG. 1 illustrates a network architecture 100 used to implement computationally efficient depth mapping using dual cameras and a sparse active depth sensor, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

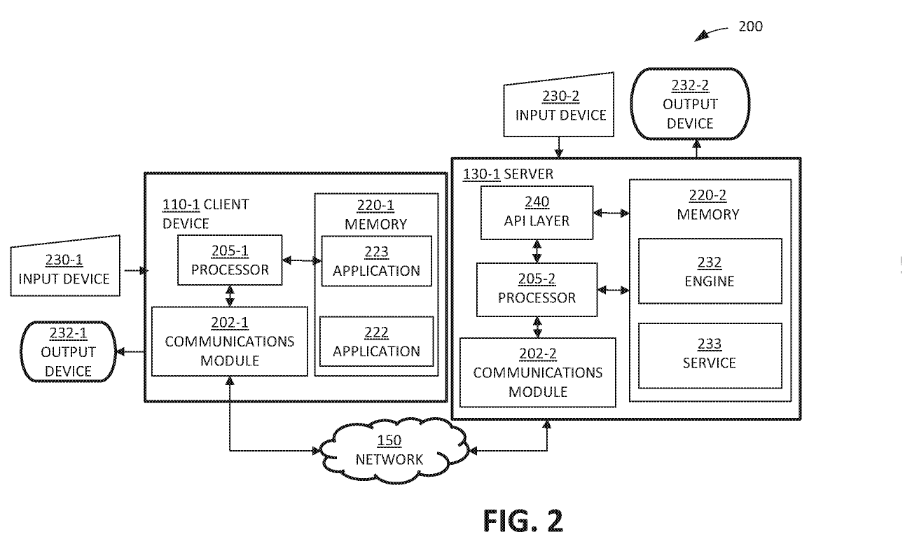

FIG. 2 is a block diagram illustrating details of a system 200 for computationally efficient depth mapping using dual cameras and a sparse active depth sensor, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement computationally efficient depth mapping using dual cameras and a sparse active depth sensor. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide computationally efficient depth mapping using dual cameras and a sparse active depth sensor. The application 223 may communicate with service 233 through API layer 240, for example.

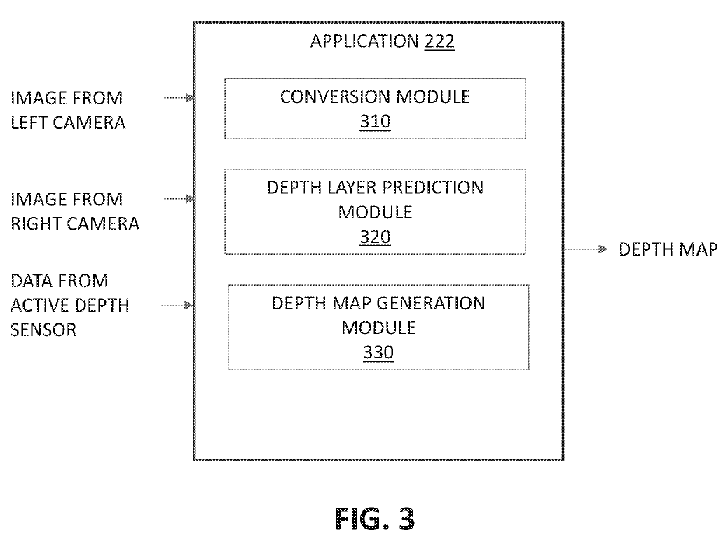

FIG. 3 depicts computationally efficient depth mapping using dual cameras and a sparse active depth sensor, in accordance with an illustrative embodiment. Application 222 is the same as application 222 in FIG. 2.

Application 222 receives depth data of a scene. The depth data is a result of an active depth determination of one or more points in the scene, obtained using an active sensor such as sonar or a laser. Thus, in some implementations of application 222 the depth data is a set of points in a three-dimensional coordinate system.

Some implementations of application 222, used in, e.g., a headset with left and right cameras, compute two reprojected values of a sensor measurement at a target resolution, one each for the left and right cameras, by multiplying a 4x4 left transformation matrix K·[R|t|] by the raw sensor measurements (N points x 4 values for each point) and by multiplying a 4x4 right transformation matrix K·[R|t|] by the same raw sensor measurements. However, the target resolution is usually large enough that reprojecting directly to the target resolution results in sparse two-dimensional maps that are difficult to process in a depth value generation model such as a CNN. Thus, another implementation of application 222, used in, e.g., a headset with left and right cameras, performs two reprojections for the left camera, one at the target resolution (denoted by p1) and one at a lower (e.g., half of the) resolution than the target resolution (denoted by p2), and combines the two reprojections using the expression y = p1 if p1 is empty else p2. The implementation performs a similar reprojection for the right camera. Although left and right cameras are typical, other camera configurations are also possible. Combining multiple reprojections in the manner described herein condenses a resulting two-dimensional map for easier processing (as compared to a sparser map) in a depth value generation model such as a CNN. After reprojection, the depth data is in a 32-bit floating point format, and thus there are a plurality of 32-bit floating point depth values.

32-bit floating point depth values are computationally expensive to process in on-device hardware through a depth value generation model such as a CNN, potentially causing undesirable latency if the processor(s) implementing the model cannot process 32-bit floating point depth values fast enough to generate a real-time result. Thus, conversion module 310 encodes a 32-bit floating point depth value into a first signed 8-bit integer and a second signed 8-bit integer. Module 310 computes a first signed 8-bit integer, denoted by y1, using the expression y1 = int8(y*scale1). Module 310 computes a second signed 8-bit integer, denoted by y2, using the expression y2 = int8(sin(y/T)*scale2. Here, scale1, T, and scale2 denote customizable scale factors, int8() denotes a function converting a value into a signed 8-bit integer, and y denotes the projected raw sensor measurement.

Using a trained CNN, a presently available technique, depth layer prediction module 320 uses images from the dual cameras, the first signed 8-bit integer, and the second signed 8-bit integer to predict a plurality of depth layer maps and a probability map. In one implementation of module 320, the trained CNN includes a first encoder portion, a second encoder portion, and a decoder portion. In the implementation, the first encoder portion uses the signed 8-bit integers to predict one output, the second encoder portion uses the images from the dual cameras to predict another output, and the decoder portion uses the encoder outputs to predict a plurality of depth layer maps and a probability map. The depth layer maps include the CNN’s predicted depth data of a layer of the scene and the probability map includes the CNN’s prediction of the relative weights among the depth layers. For each pixel, the probability value guides the selection among the multiple candidate depth values of the depth layers. The depth layer maps and probability maps are aligned with each other, so that corresponding pixels in each map refer to the same x-y coordinates in the scene. In one implementation of module 320, the plurality of depth layer maps includes a foreground map (comprising depth data of a foreground portion of the scene) and a background map (comprising depth data of a background portion of the scene). In another implementation of module 320, the plurality of depth layer maps includes a foreground map, an intermediate map (comprising depth data of an intermediate-depth portion of the scene), and a background map. In another embodiment, the plurality of depth layer maps includes four or more depth layer maps, each including depth data of a layer of the scene. In some implementations of module 320, the depth layer maps have a lower resolution than the probability map. In one implementation of module 320, the depth layer maps are 320x256 and the probability map is 640x512. In another implementation of module 320, the depth layer maps are 160x128 and the probability map is 640x512. Note that the depth layer maps need not all have the same resolution, and other resolutions for both depth layer and probability maps are also possible.

Depth map generation module 330 generates a depth map of a scene by selecting pixels from the plurality of depth layer maps according to the probability map. The depth map of a scene includes predicted depth data for coordinates in the scene that did not have depth data obtained using active sensing. If the depth layer maps are not the same resolution as the probability map, module 330 converts the depth layer maps to the same resolution as the probability map, for example using bilinear upsampling, a presently available technique. Because the depth layer maps and probability maps are aligned with each other, in an implementation of module 320 implementing a foreground and background depth layer maps, module 330 generates the depth map by selecting a pixel from the foreground depth map if an entry in the probability map corresponding to the pixel is greater than a threshold value (e.g., 0.5) and selecting the corresponding pixel from the background depth map otherwise. In an implementation of module 320 implementing foreground, intermediate ground, and background depth layer maps, module 330 generates the depth map by selecting a pixel from the foreground depth map if an entry in the probability map corresponding to the pixel is greater than a first threshold value (e.g., 0.33), selecting the corresponding pixel from the intermediate ground depth map if the entry in the probability map is between the first threshold value and a second, lower, threshold value (e.g., between 0.33 and 0.66), and selecting the corresponding pixel from the background depth map otherwise. Other implementations using higher numbers of probability maps select pixels from depth layer maps similarly.

In implementations of application 222, using two signed 8-bit integers as input is faster than using a 32-bit floating point depth value, as the first few layers of an encoder portion of the CNN do not need to perform computations on floating point data. Predicting depth layer maps and combining the results into a final depth map is also faster than using a decoder portion of the CNN to produce a final depth map. As a result, implementations described herein are computationally efficient enough to execute in real time on existing MR devices such as headsets.

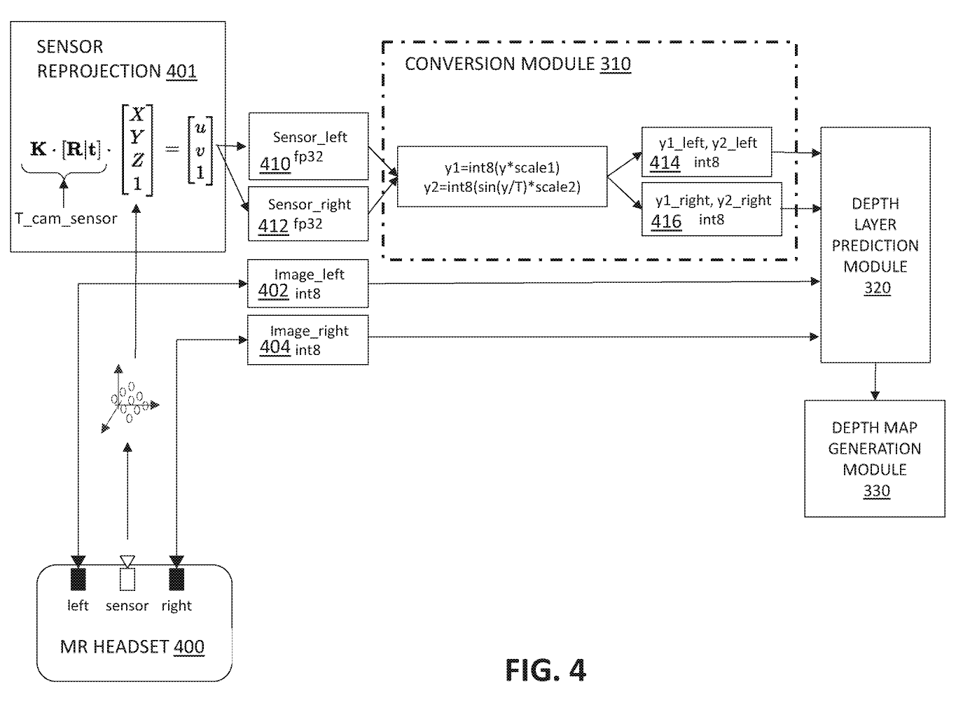

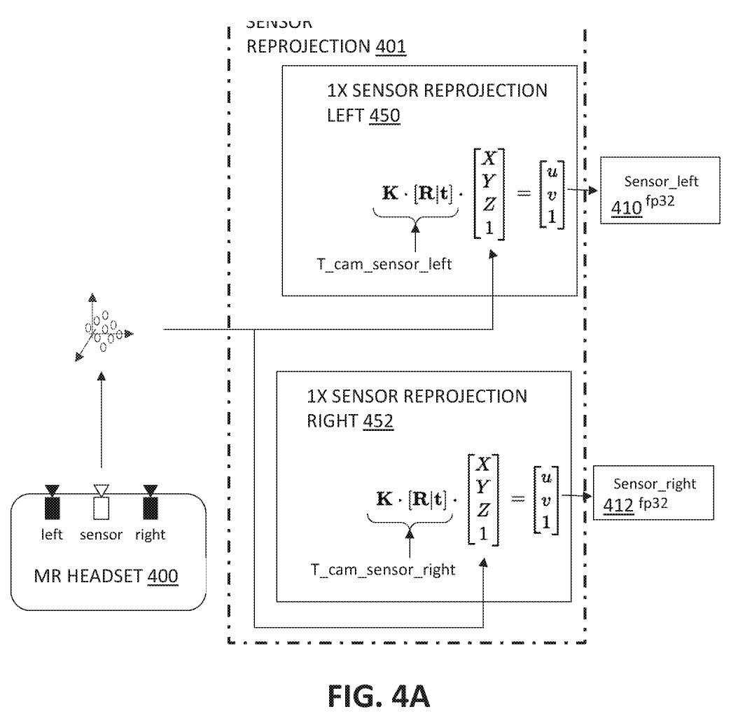

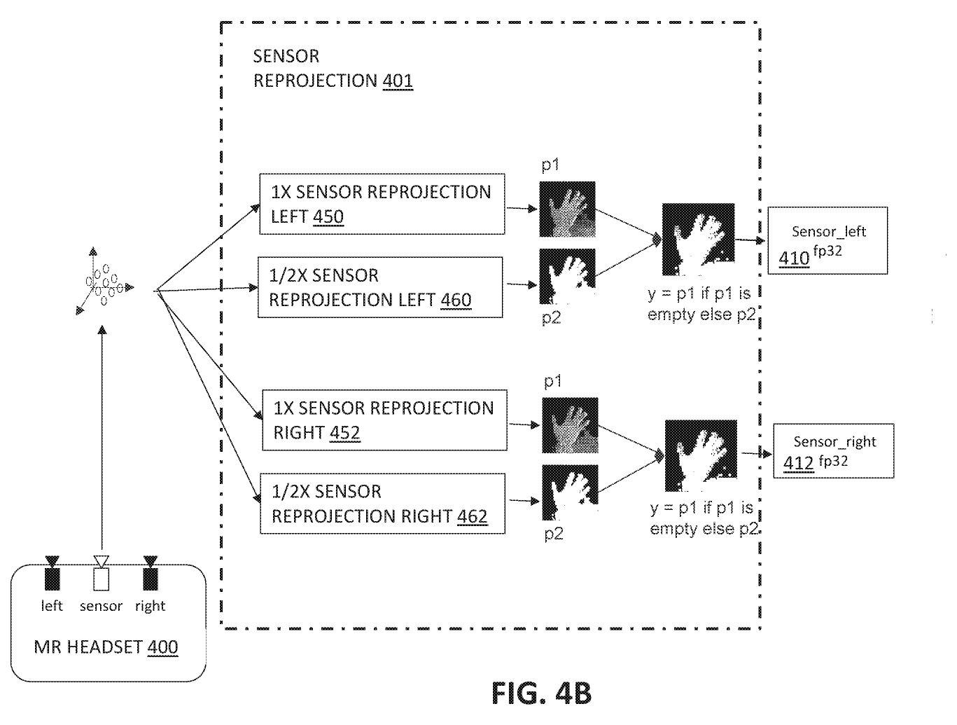

FIG. 4 depicts an example of computationally efficient depth mapping using dual cameras and a sparse active depth sensor, in accordance with an illustrative embodiment. The example can be executed using application 222 in FIG. 2. Conversion module 310, depth layer prediction module 320, and depth map generation module 330 are the same as conversion module 310, depth layer prediction module 320, and depth map generation module 330 in FIG. 3.

MR headset 400 includes a left camera producing image_left 402, a right camera producing image_right 404, and a depth sensor producing sensor_left depth 410 and sensor_right depth 412. Sensor reprojection 401 computes two reprojected values of a sensor measurement at a target resolution, one each for the left (sensor_left depth 410) and right (sensor_right depth 412) cameras.

Conversion module 310 encodes sensor_left depth 410 (in 32-bit floating point format) into signed 8-bit integers 414 (y1_left and y2_left). Conversion module 310 encodes sensor_right depth 412 (in 32-bit floating point format) into signed 8-bit integers 416 (y1_right and y2_right). Image left 402 and image right 404, along with 414 and 416, are passed to layer prediction module 320 and depth map generation module 330.

FIG. 4A depicts more detail of an example of computationally efficient depth mapping using dual cameras and a sparse active depth sensor, in accordance with an illustrative embodiment. Sensor reprojection 401, sensor_left depth 410, sensor_right depth 412, and MR headset 400 are the same as sensor reprojection 401, sensor_left depth 410, sensor_right depth 412, and MR headset 400 in FIG. 4.

Within a depicted implementation of sensor reprojection 401, 1x sensor reprojection left 450 computes sensor_left depth 410, a reprojected value of a sensor measurement at a target resolution, by multiplying a 4x4 left transformation matrix K·[R|t|] by a raw sensor measurement (N points x 4 values for each point). 1x sensor reprojection right 452 computes sensor_right depth 412, a reprojected value of a sensor measurement at a target resolution, by multiplying a 4x4 right transformation matrix K·[R|t|] by the same raw sensor measurement.

FIG. 4B depicts more detail of another example of computationally efficient depth mapping using dual cameras and a sparse active depth sensor, in accordance with an illustrative embodiment. Sensor reprojection 401, sensor_left depth 410, sensor_right depth 412, and MR headset 400 are the same as sensor reprojection 401, sensor_left depth 410, sensor_right depth 412, and MR headset 400 in FIG. 4. 1x sensor reprojection left 450 and 1x sensor reprojection right 452 are the same as 1x sensor reprojection left 450 and 1x sensor reprojection right 452 in FIG. 4A.

Within a depicted implementation of sensor reprojection 401, 1x sensor reprojection left 450 computes a reprojected value at a target resolution (denoted by p1) in a manner described herein. 1/2x sensor reprojection left 460 computes a reprojected value at a lower (e.g., half of the) resolution than the target resolution (denoted by p2) in a manner described herein. Sensor reprojection 401 combines the two reprojections using the expression y = p1 if p1 is empty else p2, generating sensor_left depth 410. Similarly, 1x sensor reprojection right 452 computes a reprojected value at a target resolution (denoted by p1) in a manner described herein. 1/2x sensor reprojection right 462 computes a reprojected value at a lower (e.g., half of the) resolution than the target resolution (denoted by p2) in a manner described herein. Sensor reprojection 401 combines the two reprojections using the expression y = p1 if p1 is empty else p2, generating sensor_right depth 412. Note that 1/2x sensor reprojection left 460 and 1/2x sensor reprojection right 462 need not reproject at half the target resolution, regardless of their labelling.

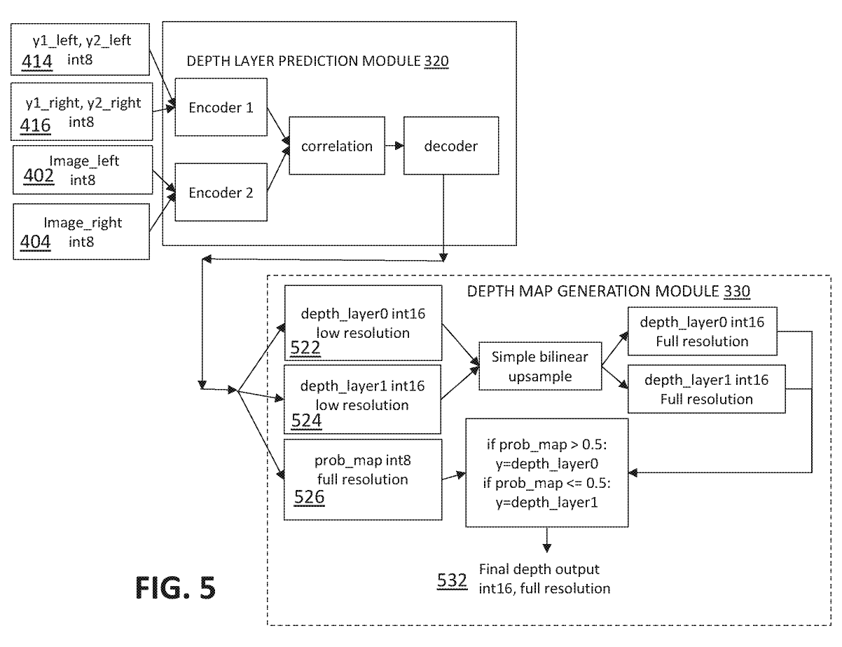

FIG. 5 depicts a continued example of computationally efficient depth mapping using dual cameras and a sparse active depth sensor, in accordance with an illustrative embodiment. Conversion module 310, depth layer prediction module 320, and depth map generation module 330 are the same as conversion module 310, depth layer prediction module 320, and depth map generation module 330 in FIG. 3. Image left 402 and image right 404, 414, and 416 are the same as image left 402 and image right 404, 414, and 416 in FIG. 4.

As depicted, depth layer prediction module 320 uses image_left 402 and image_right 404, 414(y1_left and y2_left), and 416 (y1_right and y2_right) to predict depth_layer0 522 and depth_layer1 524 (both depth layer maps) and prob_map 526, a probability map. Depth map generation module 330 generates, by selecting pixels from the depth layer maps according to the probability map, final depth output 532, a depth map of a scene for use by MR headset 400 in FIG. 4.

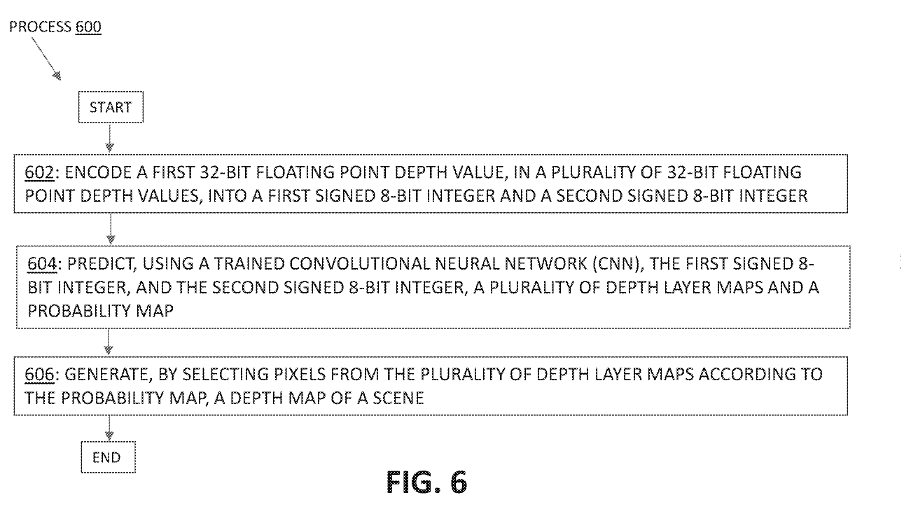

FIG. 6 depicts a flowchart of an example process for computationally efficient depth mapping using dual cameras and a sparse active depth sensor, in accordance with an illustrative embodiment. Process 600 can be implemented in application 222 in FIG. 2.

At block 602, the process encodes a first 32-bit floating point depth value, in a plurality of 32-bit floating point depth values, into a first signed 8-bit integer and a second signed 8-bit integer. At block 604, the process predicts, using a trained CNN, the first signed 8-bit integer, and the second signed 8-bit integer, a plurality of depth layer maps and a probability map. At block 606, the process generates, by selecting pixels from the plurality of depth layer maps according to the probability map, a depth map of a scene. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
encoding a first 32-bit floating point depth value, in a plurality of 32-bit floating point depth values, into a first signed 8-bit integer and a second signed 8-bit integer;
predicting, using a trained convolutional neural network (CNN), the first signed 8-bit integer, and the second signed 8-bit integer, a plurality of depth layer maps and a probability map; and
generating, by selecting pixels from the plurality of depth layer maps according to the probability map, a depth map of a scene.

2. The computer-implemented method of claim 1, wherein the first 32-bit floating point depth value is a result of reprojecting a result of an active depth determination of a point in the scene into a camera in a pair of cameras.

3. The computer-implemented method of claim 1, wherein the first signed 8-bit integer is equal to the first 32-bit floating point depth value converted into integer form.

4. The computer-implemented method of claim 1, wherein the second signed 8-bit integer is equal to the first 32-bit floating point depth value modulated by a sine function.

5. The computer-implemented method of claim 1, wherein the trained CNN comprises a first encoder portion, a second encoder portion, and a decoder portion.

6. The computer-implemented method of claim 1, wherein the plurality of depth layer maps comprises a foreground map comprising depth data of a foreground portion of the scene and a background map comprising depth data of a background portion of the scene.

7. The computer-implemented method of claim 1, wherein the plurality of depth layer maps comprises a foreground map comprising depth data of a foreground portion of the scene, an intermediate map comprising depth data of an intermediate-depth portion of the scene, and a background map comprising depth data of a background portion of the scene.

8. The computer-implemented method of claim 1, wherein the plurality of depth layer maps each have a lower resolution than the probability map.

9. A non-transitory computer-readable medium storing a program, which when executed by a computer, configures the computer to:
encode a first 32-bit floating point depth value, in a plurality of 32-bit floating point depth values, into a first signed 8-bit integer and a second signed 8-bit integer;
predict, using a trained convolutional neural network (CNN), the first signed 8-bit integer, and the second signed 8-bit integer, a plurality of depth layer maps and a probability map; and
generate, by selecting pixels from the plurality of depth layer maps according to the probability map, a depth map of a scene.

10. The non-transitory computer-readable medium of claim 9, wherein the first 32-bit floating point depth value is a result of reprojecting a result of an active depth determination of a point in the scene into a camera in a pair of cameras.

11. The non-transitory computer-readable medium of claim 9, wherein the first signed 8-bit integer is equal to the first 32-bit floating point depth value converted into integer form.

12. The non-transitory computer-readable medium of claim 9, wherein the second signed 8-bit integer is equal to the first 32-bit floating point depth value modulated by a sine function.

13. The non-transitory computer-readable medium of claim 9, wherein the trained CNN comprises a first encoder portion, a second encoder portion, and a decoder portion.

14. The non-transitory computer-readable medium of claim 9, wherein the plurality of depth layer maps comprises a foreground map comprising depth data of a foreground portion of the scene and a background map comprising depth data of a background portion of the scene.

15. The non-transitory computer-readable medium of claim 9, wherein the plurality of depth layer maps comprises a foreground map comprising depth data of a foreground portion of the scene, an intermediate map comprising depth data of an intermediate-depth portion of the scene, and a background map comprising depth data of a background portion of the scene.

16. The non-transitory computer-readable medium of claim 9, wherein the plurality of depth layer maps each have a lower resolution than the probability map.

17. A system comprising:
a processor; and
a non-transitory computer readable medium storing a set of instructions, which when executed by the processor, configure the system to:
encode a first 32-bit floating point depth value, in a plurality of 32-bit floating point depth values, into a first signed 8-bit integer and a second signed 8-bit integer;
predict, using a trained convolutional neural network (CNN), the first signed 8-bit integer, and the second signed 8-bit integer, a plurality of depth layer maps and a probability map; and
generate, by selecting pixels from the plurality of depth layer maps according to the probability map, a depth map of a scene.

18. The system of claim 17, wherein the first 32-bit floating point depth value is a result of reprojecting a result of an active depth determination of a point in the scene into a camera in a pair of cameras.

19. The system of claim 17, wherein the first signed 8-bit integer is equal to the first 32-bit floating point depth value converted into integer form.

20. The system of claim 17, wherein the second signed 8-bit integer is equal to the first 32-bit floating point depth value modulated by a sine function.
